(19) United States
(12) Patent Application Publication
(10) Pub. No.: US 2008/0031491 A1
(43) Pub. Date: Feb. 7, 2008

(54) Anomaly detection in a video system

(75) Inventors: Yunqian Ma, Roseville, MN (US); Michael E. Bazakos, Bloomington, MN (US); Kwong Wing Au, Bloomington, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/498,923

(22) Filed: Aug. 3, 2006

(51) Int. Cl. G06K 9/00; G06K 9/46; G06K 9/62; G06K 9/66

(52) U.S. Cl. 382/103; 382/224; 382/190

(57) ABSTRACT

In an embodiment, a video processor is configured to identify anomalous or abnormal behavior. A hierarchical behavior model based on the features of the complement of the abnormal behavior of interest is developed. For example, if the abnormal behavior is stealing or shoplifting, a model is developed for the actions of normal shopping behavior (i.e., not stealing or not shoplifting). Features are extracted from video data and applied to an artificial intelligence construct such as a dynamic Bayesian network (DBN) to determine if the normal behavior is present in the video data (i.e, the complement of the abnormal behavior). If the DBN indicates that the extracted features depart from the behavior model (the complement of the abnormal behavior), then the presence of the abnormal behavior in the video data may be assumed.

### TECHNICAL FIELD

Various embodiments relate to video processing systems, and in an embodiment, but not by way of limitation, to video processing systems that detect anomalous or abnormal behavior.

### BACKGROUND

Video surveillance systems are used in a variety of applications to detect and monitor persons and/or objects within an environment. For example, in security applications, such systems are sometimes employed to detect and track individuals or vehicles entering or leaving a building facility or security gate. In other security applications, such systems may be used to monitor individuals within a store, office building, hospital, or other such setting where the health and/or safety of the occupants and/or the safekeeping of the property is of concern. A further example is the aviation industry, where such systems have been used to detect the presence of individuals at key locations within an airport such as at a security gate or in a parking garage.

In recent years, video surveillance systems have progressed from simple human monitoring of a video scene to automatic monitoring of digital images by a processor. In such a system, a video camera or other sensor captures real time video images, and the surveillance system executes an image processing algorithm. The image processing algorithm may include motion detection, motion tracking, and object classification.

While motion detection, motion tracking, and object classification have become somewhat commonplace in the art of video surveillance, and are currently applied to many situations including security surveillance, the automatic detection of certain actions or events by a video processing system is not at times an easy, simple, or straightforward endeavor. For example, in the situation of a surveillance camera in a retail store, because of the variety of ways that a person could steal (e.g., shoplift) an item, it is difficult to program a video processing system to automatically identify such behavior. Similarly, since the set of abnormal behaviors in an environment such as an airport may be infinite, the automatic detection of such abnormal behavior with a video processing system is virtually impossible.

The video processing art is therefore in need of a video processing system that can identify such difficult to identify actions.

### SUMMARY

In an embodiment, a video processor is configured to identify anomalous or abnormal behavior. A hierarchical behavior model based on the features of the complement of the abnormal behavior of interest is developed. For example, if the abnormal behavior is stealing or shoplifting, a model is developed for the actions of normal shopping behavior (i.e., not stealing or not shoplifting). Features are extracted from video data and applied to an artificial intelligence construct such as a dynamic Bayesian network (DBN) to determine if the normal behavior is present in the video data (i.e, the complement of the abnormal behavior). If the DBN indicates that the extracted features depart from the behavior model (the complement of the abnormal behavior), then the presence of the abnormal behavior in the video data may be assumed.

### BRIEF DESCRIPTION OF THE DRAWINGS

FIG. 1 illustrates a process to identify anomalous or abnormal behavior in video data.

FIG. 2 illustrates an example embodiment of a Bayesian network that may be used in connection with one or more embodiments.

FIG. 3 illustrates a block diagram of a computer architecture upon which one or more embodiments of the present disclosure may operate.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include digital/analog signal processing systems, software, data processing hardware, data processing system-implemented methods, and various processing operations, further described herein.

A number of figures show block diagrams of systems and apparatus of embodiments of the present disclosure. A number of figures show flow diagrams illustrating systems and apparatus for such embodiments. The operations of the flow diagrams will be described with references to the systems/apparatuses shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

One or more embodiments of the present disclosure provide a system and method that identify particular anomalous or abnormal behaviors in a video data stream by identifying the corresponding normal behaviors (i.e., the complement of the abnormal behavior) in the video stream. Any deviation from the expected normal behavior model indicates that the anomalous or abnormal behavior of interest, such as the theft of an item in a store, may have just occurred. The system and method described herein are particularly useful if the anomalous or abnormal behavior is not easily modeled because there are too many ways that the anomalous behavior can manifest itself, therefore making it very difficult to detect the particular abnormal behavior. For example, a person can steal an item in many ways, for example by hiding the item under his clothes, putting it in his pockets, or putting it in his bag, just to like a few. By comparison, normal shopping behaviors only include a few patterns, such as putting the item into his shopping cart or putting the item back on the shelf.

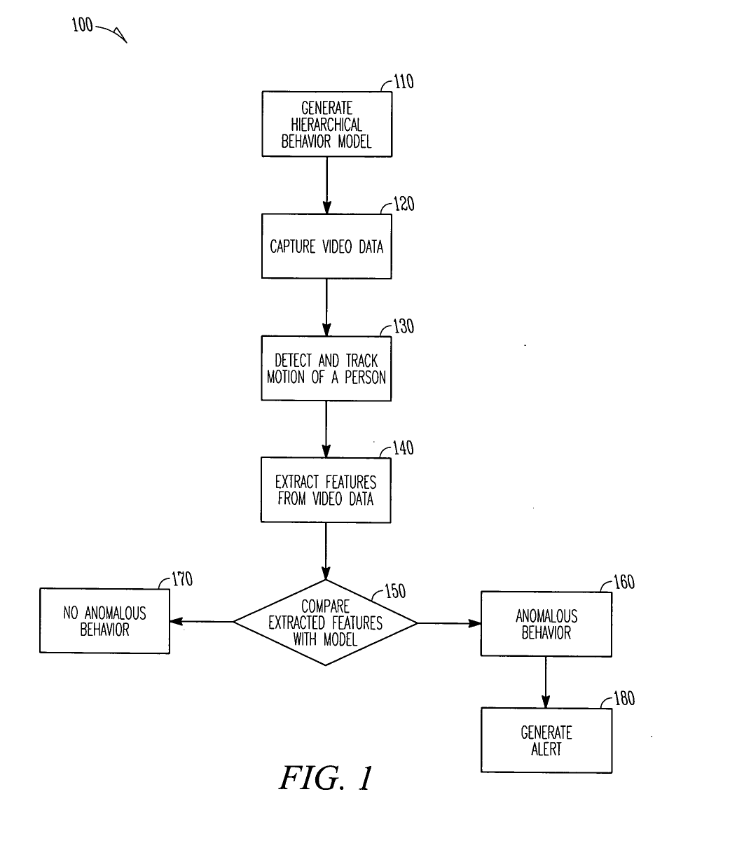

FIG. 1 illustrates a process 100 that may be used in connection with identifying anomalous or abnormal behavior in video data. For ease of illustration, a single type of anomalous behavior, shoplifting, is used to explain and illustrate the disclosed embodiments. However, it should be kept in mind that other anomalous behaviors could also be identified with process 100, and the disclosure is not limited to the situation of identifying shoplifting incidents. For example, the embodiments of the disclosure could also be applied to other anomalous incidents such as a traffic accident or other highway mishap (by modeling a normal flow of traffic).

Referring to FIG. 1, a normal process of shopping for items by a person is modeled at operation 110. In an embodiment, this process models all the body movements that are typical of a person when he or she is shopping. For example, in a model, data may be collected regarding features that are related to shopping. Such features may include the location of a person, the movement (including speed) or lack of movement of the person, the direction of the movement, the posture of the person, and the arm and other body movements of the person.

In the example of identifying a potential shoplifting incident (by identifying normal shopping behavior), the system may model a shopper pushing a shopping cart in an aisle, stopping in the aisle, reaching for an item on a shelf, removing the item from the shelf, examining the item, moving the arm so as to return the item to the shelf, and then continuing to move down the aisle. Similarly, the system may model a shopper pushing a shopping cart in an aisle, stopping in the aisle, reaching for an item on a shelf, removing the item from the shelf, examining the item, moving the arm and bending the torso slightly so as to place the item in the shopping cart, and continuing to move down the aisle. Both of these examples are modeled as normal behavior in a shopping or other commercial environment.

After the modeling at operation 110, the system is set up to capture video data in a shopping environment. To the extent possible, the shopping environment should be similar to the environment in which the model was created. At operation 120, video sensors are placed at strategic points in the shopping environment and video data is captured from those video sensors. In receiving that video data, the video processor of the system detects motion in the video data, identifies/classifies that motion as that of a person, and then tracks the motion of that person at operation 130. In an embodiment, when the motion of that person stops, the processor begins to extract features of the person from the video data at operation 140. Specifically, the processor identifies an extension of the person's arm towards the shelf for an item and the removal of that item from the shelf. The processor may additionally examine the portion of the video data at the hand to determine if the person has removed an item from the shelf. This can be accomplished by determining if a blob (representing the item) is present at the end of the person's hand. The processor then may determine if the person examines the item that he or she has just removed from the shelf. The processor may do this by identifying a downward tilt to the head, and a position of the arms indicating that the person is holding the item in front of him or her for examination. The processor may then determine that the person extends his or her arm back to the shelf to return the item, or that the person extends his or her arm forward and downward and bends slightly at the waist to place the item in the shopping cart, as illustrated by decision block 150. If neither of these two arm and body movements occur, then the processor flags this video data as a potential theft or shoplifting situation at 160. If either one of these two features have been identified, then this is the normal modeled behavior as indicated at block 170, and this video data is not flagged as a potential theft incident.

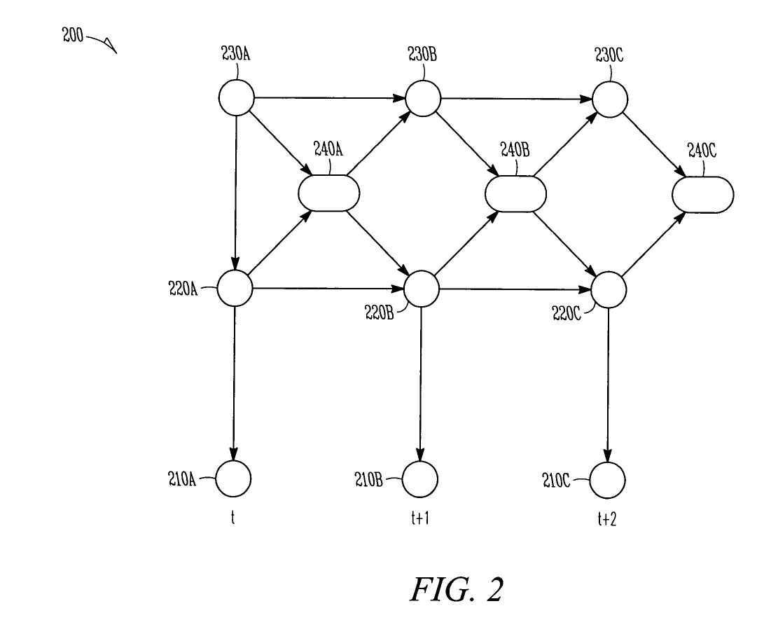

FIG. 2 illustrates an example of a dynamic Bayesian network (DBN) that may be used in connection with identifying anomalous and abnormal behaviors in video data by detecting normal (modeled) behavior in the video data. The network 200 includes observation nodes 210A, 210B, and 210C, ‘low level behavior’ nodes 220A, 220B, and 220C, ‘high level behavior nodes’ 230A, 230B, and 230C, and ‘finish’ nodes 240A, 240B, and 240C, which can be represented by a Boolean value. The ‘low level behavior’ variable is discrete, and takes on M possible values or states (e.g., a shopper's hand reaching for an item, a shopper examining the item, a shopper placing the item in a shopping cart, a shopper returning the item to the shelf, etc.) The ‘high level behavior’ variable is discrete, takes on N possible values or states, and may represent N normal shopping behaviors (e.g., a shopper buying an item, or a shopper not buying an item). The ‘high level behavior’ is therefore a combination of several ‘low level behaviors’. For example, the 'shopper buying an item’ high behavior is a sequence of the low level behaviors ‘the shopper's hand reaching for an item’, ‘the shopper examining the item’, and the shopper placing the item in a shopping cart’. If any of the ‘finish’ nodes 240A, 240B, or 240C are set to the Boolean value 1 (because the high level value has been identified), then the finish node switches to different high level behavior. If the ‘finish’ node value is 0, then it remains the same high level behavior. The network 200 of FIG. 2 represents the times t, t+1, and t+2. While FIG. 2 illustrates a Bayesian network with three sets of nodes (e.g., 220a , 220B, and 220C) representing a three-slice temporal Bayesian network, other Bayesian networks utilizing other nodes are within the scope of the disclosure. For a video sequence of length T, the network 200 may be divided up into T time segments or slices. Once again, the network 200 is merely an example, and it can be extended to more complex situation. For example, there may be another layer on top of the ‘high level behavior nodes’ 230A, 230B and 230C that serve as ‘more complex’ nodes, and the ‘low level behavior’ nodes may have subsequent duration models to represent the duration of each ‘low level behavior’ state. The parameters in the DBN 200, including a transition model, an observation model, and the initial state distribution, may be learned from the training data using DBN learning methods. For ease of illustration, the present disclosure focuses on the operational phase and the testing phase of the DBN network.

In a particular embodiment, the observation nodes 210 represent the observations of the network 200, which can be extracted from the features of a tracked object. The relationship of the ‘low level behavior’ node 220A and the ‘observation’ node 210A can be represented by an observation model which is learned from training data. For example, in a shopping environment, one observation at observation node 210A at time t may be the physical distance between the location of a person's hand and the location of an item on a shelf in the store while that person is standing in place (i.e., not walking down the aisle). Based on the DBN inferences, the observations at 210A may change the ‘low level node’ 220A to the state of ‘the shopper's hand reaching for an item’ at time t. Since this is also a ‘high level behavior’, the Boolean value 240A remains 0, thereby indicating that at time t, the high level behavior didn't finish, and more ‘low level behaviors’ are required.

The system then processes the nodes representing the next time segment t+1 in the incoming video data. The observations at observation node 210B at time t+1 may include the person standing still, head tilted down slightly, and upper arms at the person's side and forearms in front of the person. Based on the DBN inferences, these observations at 210B at time t+1 may set the ‘low level behavior’ node 220B at time t+1 to the state of ‘a shopper examining the item’. Since this is also a ‘high level behavior’, the Boolean value 240B is remains 0, thereby indicating that at time t+1, the ‘high level behavior’ didn't finish, and more ‘low level behaviors’ are required.

After verifying that the shopper has examined the item, the system processes the next observation node 210C at time t+2 . The observations at observation node 210C at time t+2 may include a shopper's arm extending out and downwards in front of him or her, and a slight bend in the waist of the shopper. Based on the DBN inferences, these observations at 210C at time t+2 can set the ‘low level behavior’ node 220C to the state of ‘a shopper placing the item in a shopping cart’. At this point, the ‘high level behavior’ of ‘a shopper buying an item’ has occurred, and the Boolean value at 240C is set to 1 at time t+2 to indicate that the system has concluded that one type of normal shopping behavior, i.e., ‘a shopper buying an item’ has been observed in this video data.

As previously disclosed, there may be N ‘high level behaviors’. Therefore, the Bayesian network 200 of FIG. 2 may also be used to determine another high level behavior such as ‘a shopper did not buy an item’. This may include a shopper removing an item from the shelf, the shopper examining the item, and the shopper returning the item to the shelf.

The first two ‘low level behaviors’ of the ‘high level behavior’ ‘the shopper did not buy the item’ is the same the first two ‘low level behaviors’ for the ‘high level behavior’ of ‘the shopper buying an item.’ Consequently, the ‘low level behavior’ 220A is in the state of ‘a shopper's hand reaching for an item’. Similarly, the ‘low level behavior’ 220B is in the state of ‘the shopper examining the item’. However, the observations at observation node 210C at time t+2 may include an upwards and outwards extension of the arm towards the shelf while the person remains in the same place (i.e., not walking). Based on the DBN inferences, these observations at 210C at time t+2 may set the ‘low level behavior’ node 220C to the state of ‘the shopper putting the item back on the shelf’. Therefore, the high level behavior ‘the shopper did not buy the item’ has occurred, and the Boolean value at 230C is set to 1 at time t+2 to indicate that the system has concluded the ‘high level behavior’ of ‘the shopper did not buy the item’. That is, the normal action of deciding not to purchase and item.

If the analysis of the results of the video data of the DBN network 200 at the final time doesn't belong to any of the N normal ‘high level behaviors’, then the system concludes that a potential theft has occurred, and it can sound an alert at 180 in FIG. 1. This alert can be audible or visual (a message on a display screen, a text message to another device, an email, etc). Security personnel can then monitor the shopper to see if any other suspicious or illegal activity occurs.

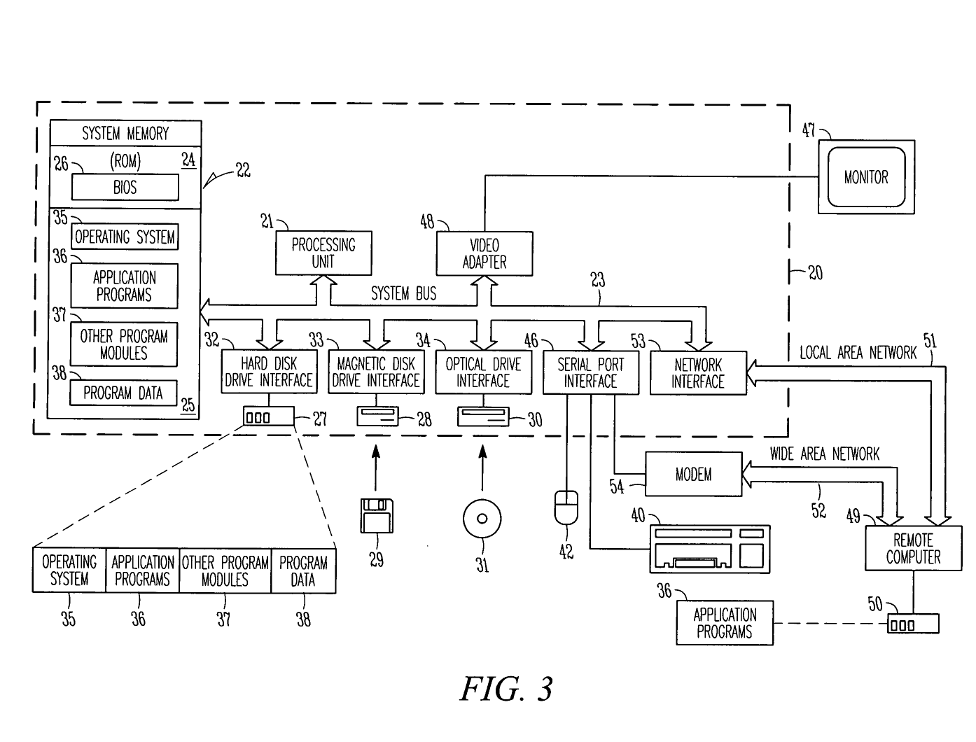

FIG. 3 is an overview diagram of a hardware and operating environment in conjunction with which embodiments of the invention may be practiced. The description of FIG. 3 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 3, a hardware and operating environment is provided that is applicable to any of the servers and/or remote clients shown in the other Figures.

As shown in FIG. 3, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 3 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

In the foregoing detailed description of embodiments of the invention, various features are grouped together in one or more embodiments for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the scope of the invention as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The abstract is provided to comply with 37 C.F.R. 1.72(b) to allow a reader to quickly ascertain the nature and gist of the technical disclosure. The Abstract is submitted with the understanding that it will not be used to interpret or limit the scope or meaning of the claims.

1. A system comprising one or more modules to:
receive video data from an environment;
extract features from the received video data;
compare the extracted features from the received video data to a model of a complement of an abnormal behavior; and
deduce that the abnormal behavior is present in the received video data when the comparison departs from the model of the complement of the abnormal behavior.

2. The system of claim 1, wherein the module to compare the extracted features and the complement model includes a dynamic Bayesian network.

3. The system of claim 1, further comprising a module to generate an alert when the extracted features do not correlate with the complement model.

4. The system of claim 1, wherein the complement model comprises a person shopping for items.

5. The system of claim 4, wherein the complement model and the received video data originate in a store environment.

6. The system of claim 4, wherein the complement model includes one or more of:
reaching for an item on a shelf;
examining the item; and
returning the item to the shelf.

7. The system of claim 4, wherein the complement model includes one or more of:
reaching for an item on a shelf;
examining the item; and
placing the item in a shopping cart or basket.

8. The system of claims 6 or 7, further comprising a module to identify an item in a hand of the shopper.

9. A process comprising:
configuring a video processor to:
receive video data from an environment;
extract features from the received video data;
compare the extracted features from the received video data to a model of a complement of an abnormal behavior; and
deduce that the abnormal behavior is present in the received video data when the comparison departs from the model of the complement of the abnormal behavior.

10. The process of claim 9, wherein the wherein the comparison of the extracted features and the complement model includes a dynamic Bayesian network.

11. The process of claim 9, further comprising configuring the video processor to generate an alert when the video processor deduces that the abnormal behavior is present in the received video data.

12. The process of claim 9, wherein the video data includes a person in a shopping environment, and further wherein the abnormal behavior comprises an action relating to a theft of an item.

13. The process of claim 12, wherein the extracted features from the received video data relate to a person removing an item from a store shelf, a person examining the item, a person returning the item to the store shelf, and a person placing the item in a shopping cart.

14. A machine readable medium comprising instructions that when executed by a processor executes a process comprising:
receiving video data from an environment;
extracting features from the received video data;
comparing the extracted features from the received video data to a model of a complement of an abnormal behavior; and
deducing that the abnormal behavior is present in the received video data when the comparison departs from the model of the complement of the abnormal behavior.

15. The machine readable medium of claim 14, wherein the comparison of the extracted features and the complement model includes a dynamic Bayesian network.

16. The machine readable medium of claim 14, further comprising instructions to generate an alert when the extracted features do not correlate with the complement model.

17. The machine readable medium of claim 14, wherein the complement model comprises a person shopping for items.

18. The machine readable medium of claim 17, wherein the complement model and the received video data originate in a store environment.

19. The machine readable medium of claim 17, wherein the complement model includes one or more of:
reaching for an item on a shelf;
examining the item; and
returning the item to the shelf.

20. The machine readable medium of claim 17, wherein the complement model includes one or more of:
reaching for an item on a shelf;
examining the item; and
placing the item in a shopping cart or basket.
